(19) United States
(12) Patent Application Publication
(10) Pub. No.: US 2015/0042201 A1
(43) Pub. Date: Feb. 12, 2015

(54) SEGMENTED MOTOR/GENERATOR WITH TRANSVERSAL FLOW GUIDANCE, HIGH THRUST TORQUE AND SMALL MASS INERTIA

(71) Applicant: Helene ORTLOFF, (US)

(72) Inventor: Peter Ortloff, Giubiasco (CH)

(73) Assignee: Helene ORTLOFF, Giubiasco (CH)

(21) Appl. No.: 14/386,014

(22) PCT Filed: Mar. 19, 2013
(86) PCT No.: PCT/EP2013/055655

§ 371 Date: Sep. 18, 2014

(30) Foreign Application Priority Data
Mar. 19, 2012 (DE) 102012005688.5

(51) Int. Cl. H02K 21/12; H02K 41/03; H02K 19/10

(52) U.S. Cl. CPC H02K 21/125; H02K 19/10; H02K 41/031
USPC 310/216.075

(57) ABSTRACT

The present invention relates to a multiphase segmented high-power synchronous machine with transversal flux guidance consisting of at least two or more double segments. The two or more double segments form segments of a linear motor or generator or segments of a rotating motor or generator. The two or more double segments consist of a row of permanent magnets and soft-magnetic yokes with one or more circumferential windings. As a result of a bidirectional structure in each case winding currents of the same magnitude flow through two equally large segments. As a result of a phase-shifted arrangement of the yokes, the thrust torque is effected in the same direction of motion. The yokes can be arranged folded down or lying side by side.

The present invention relates generally to a brushless direct current motor and/or generator and in particular a brushless high-pole multiphase transversal flux machine with permanent magnets. The invention further describes/relates to a motor/generator having high energy conversion efficiency and high efficiency or a high-power synchronous motor/generator with transversal flux guidance, high torque and low inertia, whose individual poles are segmented with offset in the returning winding.

Transversal flux machines enable a substantially higher torque density to be achieved compared with conventional machines of the same installation volume. This is based on the fact that in transversal flux machines an increase in the torque can be achieved by increasing the number of poles and the magnetic flux density. In transversal flux machines, in contrast to conventional electric machines, the magnetic flux is not longitudinally but transversally directed. That is, the electric field and the magnetic field are rotated with respect to one another by 90°.

A transversal flux machines is described, for example, in EP 1 005 136 A1, in which the scattering paths are reduced by a special configuration of the U-shaped and I-shaped yokes so that the rotational thrust is higher.

Another embodiment of a transversal flux machine which is easier to produce in terms of production technology and at the same time has the highest possible efficiency and the highest possible torque, is also known from DE 10 2006 038 576.

The higher thrust torque in transversal flux machines is achieved by a construction which consists of very many single parts. However, as a result of the easy to manufacture annular windings and the possible automatable assembly of the many individual parts, the advantages predominate.

It is the object of the present invention to provide a transversal flux motor/generator which is economical to manufacture, has a high efficiency and a high torque, i.e. to further increase the torque compared with known constructions. One aspect of the invention is in particular to simplify the fabrication process and to reduce the manufacturing costs. The transversal flux motor/generator according to the invention is in particular suitable for applications which require a small installation space and at the same time however require a high thrust torque.

The object according to the invention is solved by a multiphase segmented high-power synchronous machine with transversal flux guidance consisting of at least two or more double segments. The two or more double segments form segments of a linear motor or generator or segments of a rotating motor or generator. The two or more double segments consist of a row of permanent magnets and soft-magnetic yokes with one or more circumferential windings. As a result of a bidirectional structure in each case winding currents of the same magnitude. flow through two equally large segments. As a result of a phase-shifted arrangement of the yokes, a thrust torque is effected in the same direction of motion. The yokes can be arranged folded down or lying side by side.

According to one embodiment of the present invention, the magnets are arranged in such a manner that from two phases, one row of magnets is used and in so doing, magnetic material is saved. At the same time a saving of magnetic flux conducting materials by means of magnet concentrators is achieved. The magnetic flux materials can in particular be produced by injection-moulded MIM (Metal Injection Molding) technology as green materials or sintered materials can be used as magnetic flux conducting materials.

According to one embodiment of the present invention, the magnetic flux conducting materials consist of soft magnetic strips which are joined together with binders. The magnetic flux conducting materials made of soft magnetic strips are further encased with a plastic for stabilization and protection and the stator is preferably injection moulded by a heat-conducting plastic.

According to one embodiment of the present invention, the field strength in the magnetic flux conducting materials is intensified by magnet concentrators.

According to one embodiment of the present invention, the magnet arrangement is used by two arrangements of yoke elements jointly so that the power or the torque of the machine is substantially approximately doubled or increased by approximately 90%.

According to one embodiment of the present invention, the machine consists of two or more interconnected rotor rings on which magnets having alternating polarity (magnet poles) are attached. As a result of their structure, the two or more interconnected rotor rings with magnet poles preferably have a particularly large active and usable magnet surface.

According to one embodiment of the present invention, the segmented structure of the machine can be integrated very simply into mobile vehicles.

According to one embodiment of the present invention, the list measures constitute a weight saving, in particular when used in wind turbines in the MW range, to a considerable degree.

According to one embodiment of the present invention, the width of the pole ends of the yoke elements and the width of the magnets have a ratio of approximately 0.7.

According to one embodiment of the present invention, the edges of the yoke legs of a U-shaped yoke element have a substantially polygonal shape in the area of the pole ends so that any compression of the magnetic fields is avoided.

The invention will be better understood from the following description and the appended drawings which are only given as an example and therefore should not restrict the disclosure.

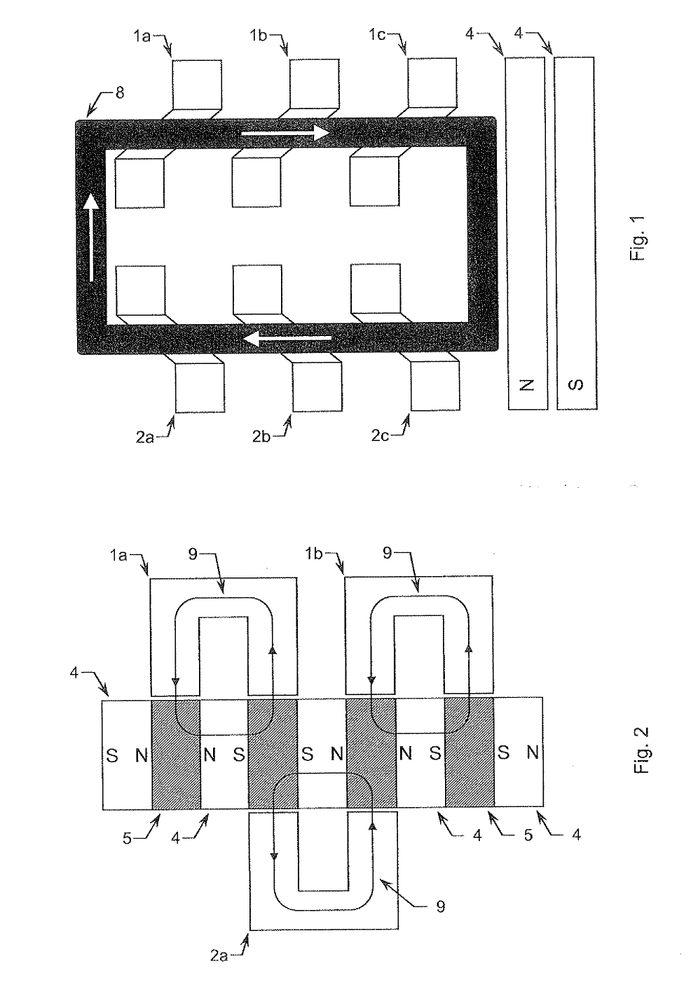

FIG. 1 shows as an example the principle of a brushless direct current motor/generator in segmented design with one phase;

FIG. 2 shows as an example the principle of double usage of the magnets and the magnet concentrator in a brushless direct current motor/generator in segmented design;

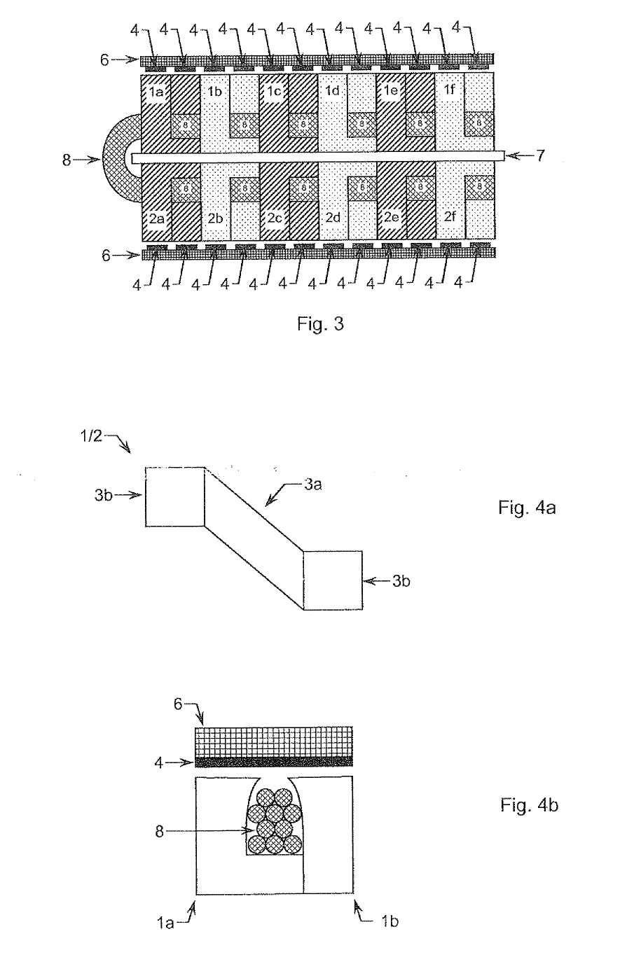

FIG. 3 shows as an example a cross-section through a brushless direct-current motor according to the invention with folded down segments; and

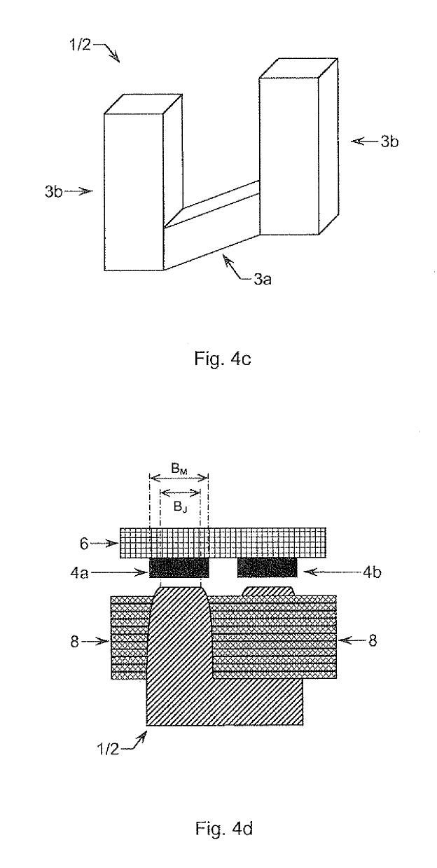

FIGS. 4a to 4d show various shapes of yoke elements according to the invention.

FIG. 1 shows as an example the principle of a brushless direct current motor/generator in segmented design with one phase in a schematically simplified view. Phase-shifted yoke elements 1a, . . . , 1c, 2a, . . . , 2c have a U-shaped shape of soft-magnetic material and enclose a transversal coil/winding 8. When energized, see arrows, in motor operation, the magnets 4 are drawn over the yokes or produce a voltage in generator operation when the magnets 4 are moved over the yoke elements 1a, . . . , 1c, 2a, . . . , 2c. The principle shown as an example in FIG. 1 uses the magnets 4 without double usage and illustrates one of several embodiments. The phase-shifted yoke elements 2a, . . . , 2c are disposed in the returning part of the transversal coil 8.

According to design, a distinction is made between unilateral transversal flux machines in which the yoke elements enclosing the winding for guiding the magnetic flux are only disposed on one side of the permanent magnets and bilateral transversal flux machines in which yoke elements are disposed on both sides of the permanent magnets.

Compared to normal EC motors, high-power synchronous motors have a ⅔ smaller winding requirement since the winding lies completely in the magnetic circuit and as a result of the double usage of the permanent magnets, a magnet mass up to 50% lower. This structure at the same time reduces the necessary magnetic flux conducting materials and therefore the weight. The transversal flux generators/motor with a double thrust torque considerably reduce the volume due to the twofold usage of the magnet material.

The material saving with increased efficiency additionally reduces the moment of inertia. The invention relates to transversal flux motors/generators which can be produced efficiently, having reduced material requirement, significantly reduced weight and increased efficiency. The energy density can be up to three times higher than in torque motors/generators.

Examples of application for such transversal flux motors/generators according to the invention are, for example, supersynchronous motors which in particular are suitable for installation in small-diameter tubes, similar to pneumatic cylinders, capstans or as spindle motors, wherein the length of the motors in these exemplary application examples is of secondary importance. An essential aspect is in particular to achieve the lowest possible speed at a high torque without requiring a transmission. Another application example is the construction of a motor/generator in the mudguard of a bicycle, where the wheel serves as rotor.

Another application example is a linear motor/generator. Here the emphasis is primarily on tools with slow movements at high power without transmission and lower weight in machine tools, where at the same time a high dynamic is required and necessary. Further application examples are external rotor motors and small motors which can be operated directly with mains voltage, supersynchronous motors in curved tracks with high path precision and the like.

### Object of the Development and Solutions

From the reasons mentioned hereinbefore the object was to develop an electric motor/generator which has the following improvements:

Slow movements
this is achieved by a high number of poles with small paths per step;

High thrust torque and high power per unit weight
this is achieved by a high number of poles with small magnets;
this is achieved by a better utilization of the magnetic surface; and/or
this is achieved by a high air gap induction.

High efficiency with slow running or low rotational speed
this is achieved by a high number of poles and limitation of the magnetic saturation. Thus, a high efficiency, low heat losses due to current flow, low iron losses and a large effective magnet surface are achieved.

This is achieved by the double utilization of the magnetic surface, which corresponds to a doubling of the usable magnetic field.

Simplified production
this is achieved by injection moulding of magnetic flux materials; and/or
this is achieved by an automated winding technology.

A low expenditure on wiring despite a high number of pole pairs
this is achieved by only one winding per phase.

The motor/generator should have a low moment of inertia
a low thrust mass moment of inertia with a higher flux intensity by reducing the magnet mass.

The motor/generator should have a higher power and thrust moment
due to the compact structure of the coil made of rectangular and/or sheet metal, the degree of copper filling and therefore the power density is increased; and/or
the efficiency is increased significantly by using NdFeB magnets and the acquisition of magnetic area.

Further embodiments according to the invention

By increasing the degree of copper filling, the power can be increased compared with round wires from a degree of filling of about 65% to about 96% by using flat materials (sheet metal) for the transversal coil 8.

As a result of a double-sided structure of the magnetic structure, the power can be increased by approximately 90% by doubling the usable magnetic surface.

A substantial part of the total losses of a motor/generator according to the invention are losses caused by the resistance of the coil. Since the resistance is lower due to the substantial increase in the usable line length as a result of the measures described previously and hereinafter, the ohmic losses are reduced.

From simulations it is shown that in particular the shaping of the pole ends of the yoke elements according to the invention can be optimised. Thus, it is shown that, for example, a ratio of pole width to magnet width of about 0.7 (see on this matter also FIG. 4d) should be strived for.

In order to reduce the tendency to saturation, the edges can furthermore be configured to be rounded according to a polygonal shape in the region of the pole ends of the yoke elements according to the invention. With such polygonal-shaped edges no magnetic field compressions can occur and the field intensity is lower at the transition.

FIG. 2 shows as an example the principle of the magnet concentrator and the double use of the magnets in a schematically simplified view. As can be identified from the previously described FIG. 1, unused parts of the magnets are always present during operation of the brushless direct-current motor/generator. In order to avoid this, a double usage of the magnets can be accomplished, which is accompanied by a higher energy density. The double usage, here likewise also designated as magnet concentrator or magnet concentrator technique, enables higher energy densities to be achieved so that a significantly higher power is obtained compared with other techniques.

For this purpose, on both sides of the magnet arrangement comprising the magnets 4 and the magnetic flux conducting material 5 (arranged in a row alternating with one another, where the polarities of the magnets are also aligned alternately opposite), yoke elements 1a, 1b, 2a are arranged in which a magnetic flux 8 is formed according to the polarity of the magnets. The yoke element 1a or 1b and the yoke element 2a are arranged on the opposite sides of the magnet arrangement.

FIG. 3 shows a principle of a possible structure of the motor/generator according to the invention with two external magnetic rings as an example for one embodiment of the present invention. A further alternative embodiment according to the invention is the structure with an internal magnetic ring with double usage of the magnets according to the previously described principle whereby a saving of magnet material is obtained.

FIG. 3 shows the yoke elements 1a, . . . , 1f and 2a, . . . , 2f with phase shift, which are arranged on a support 7 underside on underside. A transversal coil 8 is bordered by the yoke elements 1a, . . . , 1f and 2a, . . . , 2f. Magnets are provided in each case at the pole ends in the form of two magnet arrangements. The magnet arrangements each comprise return plates 6 on which, in this exemplary embodiment, individual magnets are glued on for each leg of the U-shaped yoke elements or for each pole end of each leg of the U-shaped yoke elements.

The designs in FIGS. 4a to 4b show various shapes of yoke elements according to the invention.

FIG. 4a shows a plan view of a U-shaped yoke element 1/2 according to the invention with a bridge or web 3a between legs 3b, which have a north or south pole magnetization according to the magnetizing permanent magnets (not shown). In order to increase the torque it can be provided that the poles of the U-shaped yoke element are designed to be broadened as pole shoes as can be deduced in FIG. 4b described hereinafter. Due to this broadening, the torque-effective surface is enlarged and flux density in the air gap is reduced. As can be deduced from FIG. 4a or the diagram of the yoke element according to the invention in FIG. 4c, described hereinafter, the yoke legs 3b are provided with a bridge or web 3a running obliquely with respect to their transversal planes. The obliquely running bridge or web 3a forms yoke elements having a phase shift. Preferably the legs 3b of one yoke element having a phase shift are offset by one pole division by a correspondingly configured obliquely running bridge or web 3b.

FIG. 4b shows a side sectional view of yoke elements 1a and 1b according to the invention having a transversal winding 8 and a magnet 4 with return plate 6. As can be seen from the side view, the poles of the U-shaped yoke element are designed to be broadened as pole shoes which extend into the inner region of the U-shaped yoke elements 1a and 1b. In the exemplary embodiment shown the magnet 4 extends over respectively one pole end of the yoke elements 1a and 1b according to the invention. The transversal winding 8 is here indicated as an example by a plurality of round lines. As described hereinbefore however, the transversal winding 8 can also be constructed of flat elements such as, for example, sheet metal elements.

FIG. 4c shows a simplified schematic three-dimensional view of a yoke element according to the invention with a bridge and a web 3a between two yoke legs 3b which have a north or south pole magnetization according to the magnetizing permanent magnets (not shown).

FIG. 4d shows a side view of a yoke element 1/2 according to the invention and the transversal coil/winding 8. These parts form the stator. The rotor comprises the magnets 4 with alternating north pole/south pole magnetization 4a and south pole/north pole magnetization (4b).

The width B_{J} of the pole ends of the yoke element 1/2 according to the invention and the width B_{M} of the magnets advantageously have a ratio of about 0.7. In order to reduce the tendency to saturation, the edges are preferably rounded according to a polygonal shape. The polygonal shape can be determined by means of simulation taking into account the maximum field intensity which is dependent on the choice of material. As a result of such an optimization of the polygonal edges of the pole ends of the U-shaped yoke element according to the invention, no magnetic field compressions are formed and the field intensity at the transition is lower.

### REFERENCE LIST

1, 1a, 1b, . . . : Yoke elements

2, 2a, 2b, . . . : Yoke elements

3a: (Yoke) web/bridge of a yoke element

3b: (Yoke) leg of a yoke element

4, 4a, 4b: Magnet (north-south or south-north magnetization)

5: Magnetic flux conducting material

6: Return plate

7: Support

8: Transversal coil/winding

9: Magnetic flux

1. Multiphase segmented high-power synchronous machine with transversal flux guidance consisting of at least two or more double segments which form segments of a linear motor or generator or segments of a rotating motor or generator, wherein the two or more double segments consist of a row of permanent magnets and soft-magnetic yokes with one or more circumferential windings, wherein as a result of a bidirectional structure in each case winding currents of the same magnitude flow through two equally large segments, wherein as a result of a phase-shifted arrangement of the yokes, the thrust torque is effected in the same direction of motion, wherein the yokes can be arranged folded down or lying side by side, wherein magnetic flux conducting materials made of soft magnetic strips are disposed between the permanent magnets, these strips being joined together with binders, wherein the magnetic flux conducting materials are further encased with a plastic for stabilization and protection and the stator is injection moulded by a heat-conducting plastic.

2. The high-power synchronous machine with transversal flux guidance according to claim 1, characterized in that the magnets are arranged in such a manner that from two phases, one row of magnets is used so that magnetic material is saved, wherein at the same time a saving of magnetic flux conducting materials by means of magnet concentrators is achieved, wherein the magnetic flux materials are produced by injection-moulded MIM technology as green materials or sintered materials are used as magnetic flux conducting materials.

3. (canceled)

4. The high-power synchronous machine with transversal flux guidance according to claim 1, characterized in that the field strength in the magnetic flux conducting materials is intensified by magnet concentrators.

5. The high-power synchronous machine with transversal flux guidance according to claim 1, characterized in that a phase offset of the yoke elements in multiphase machines is disposed so that the latching moment and the torque losses are very severely reduced.

6. The high-power synchronous machine with transversal flux guidance according to claim 1, characterized in that the magnet arrangement is used by two arrangements of yoke elements jointly so that the power of the machine is substantially approximately doubled.

7. The high-power synchronous machine with transversal flux guidance according to claim 1, characterized in that the machine consists of two or more interconnected rotor rings with magnet poles which as a result of their structure have a particularly large active and usable magnet surface.

8. The high-power synchronous machine with transversal flux guidance according to claim 1, characterized in that the segmented structure of the machine can be integrated very simply into mobile vehicles.

9. (canceled)

10. The high-power synchronous machine with transversal flux guidance according to claim 1, characterized in that the width of the pole ends of the yoke elements and the width of the magnets have a ratio of approximately 0.7.

11. The high-power synchronous machine with transversal flux guidance according to claim 1, characterized in that the edges of the yoke legs have a substantially polygonal shape in the area of the pole ends.
